(19) United States
(12) Patent Application Publication
(10) Pub. No.: US 2005/0004858 A1
(43) Pub. Date: Jan. 6, 2005

(54) Energy advisory and transaction management services for self-serving retail electricity providers

(76) Inventors: Andre E. Foster, Smyrna, GA (US); Kevin Greiner, Decatur, GA (US)

Correspondence Address: WOMBLE CARLYLE SANDRIDGE & RICE, PLLC, P.O. BOX 7037, ATLANTA, GA, 30357-0037, US

(21) Appl. No.: 10/919,155

(22) Filed: Aug. 16, 2004

(51) Int. Cl. G06F 17/60

(52) U.S. Cl. 705/36

(57) ABSTRACT

Methods for assisting and enabling a large industrial or business consumer of energy to become a self-serving retail electricity provider in a deregulated energy market. Performed by an energy advisory and transaction management service provider, one method registers the large business energy consumer with the state public utility commission, assists the business to qualify as a scheduling entity with an independent service operator, and establishes the business as a bilateral trading partner of wholesale energy merchants. In another method, the business processing outsourcing service assists the business in energy purchasing and risk management decisions by forecasting zonal load requirements for the business. A price forecasting analysis is compared with supply offers from wholesale energy merchants and bilateral transactions for energy supply are brokered between the business and the wholesale energy merchants. In another method, the business process outsourcing service assists the business to manage electronic transactions with an independent service operator and a transmission and distribution service provider. A daily load forecast for the business is updated and compared with energy purchase commitments to identify imbalances between supply and demand. The outsourcing service submits a daily schedule of forecasted sub-hourly load and purchase and sale commitments to the independent system operator. The outsourcing service receives and processes invoices from market participants and generates financial settlement reports for the business.

### CROSS-REFERENCE TO RELATED APPLICATION

This application is related to co-pending and commonly assigned patent application “System and Method for Energy Price Forecasting Automation,” U.S. patent application Ser. No. 10/826,422, filed on Apr. 16, 2004.

### BACKGROUND OF THE INVENTION

The present invention relates generally to providing energy portfolio advisory and transaction management services for large energy consumers.

Deregulation and restructuring of energy markets change the way that large commercial and industrial (C&I) companies purchase energy and manage risk. A deregulated market often provides customers with more choices with respect to electricity suppliers, pricing structures, and contractual terms. However, purchasing electricity in a deregulated market also requires greater vigilance with respect to negotiating contracts and mitigating price risk than what is typical in a regulated market setting, where prices are set by a regulatory authority based on an approved rate of return.

Retail energy market restructuring also spawns a new set of market participants that (a) assume certain responsibilities that were historically performed by an integrated utility, and (b) facilitate transactions and sharing of data among a newly diverse group of market participants. This new set of market participants includes the business entities identified in the following paragraphs.

Retail Electricity Providers (REPs) are entities registered to sell electricity to retail customers. These entities supply the full electricity requirements of end-user customers under a set of negotiated contractual terms.

The Independent System Operator (ISO) is a governmental entity that is responsible for forecasting demand, coordinating wholesale market activity, ensuring electric system reliability, and providing financial settlement information to market participants.

Wholesale Energy Merchants are entities that operate power plants, and purchase and sell electricity and reliability services to bilateral counterparties (e.g., other Wholesale Energy Merchants and REPs) and to the ISO.

Transmission and Distribution Service Providers (TDSPs) are entities that operate and maintain the electrical transmission and distribution infrastructure and provide metering services.

Transaction Management Service Providers are entities that provide the electronic systems to receive, process, and send information among the various market participants.

In a restructured electric market, a C&I customer typically enters into a contract with a REP for its full electricity requirements at a fixed, variable, or hybrid price that covers the customer's aggregate consumption within a given utility distribution area or wholesale market zone. The REP is financially responsible to source all power volumes consumed by the customer, on a sub-hourly basis, from Wholesale Energy Merchants and the ISO. The REP is also responsible for numerous market interface transactions, including:
1. managing data transactions with the ISO, such as submittal to the ISO of load forecasts and bilateral energy purchases;
2. financial settlements with the ISO for balancing energy, ancillary services provision, and administrative charges; and
3. management of electronic transactions with the TDSPs to facilitate the switching of accounts, and the processing of meter and billing information.

The REP thus plays the roles of both a financial and operational middleman, by purchasing power in wholesale markets and managing all of the interactions with market participants on its customers' behalf.

### SUMMARY OF THE INVENTION

The present invention is directed to an energy portfolio and transaction management service that enables a large end-user consumer of electricity, such as a manufacturing company or commercial retail chain, to become a Self-Serving Retail Electricity Provider (“SSREP”). By becoming an SSREP, such companies can directly acquire wholesale power supply from numerous market participants rather than contracting with a commercial REP for all of its power requirements.

An SSREP can realize economic benefits in the form of lower energy costs, risk reduction, and enhanced contracting flexibility. However, as an SSREP, an end-user consumer of electricity must self-perform numerous commercial functions that are normally performed by a commercial REP. The complexities of becoming certified and operating as an SSREP have prevented end-users from taking advantage of self-supplying their electricity needs. Additionally the investment involved in systems, controls, and personnel makes self-supply unattractive for many companies.

The invention specifically addresses these market realities in the form of a method for providing a comprehensive, outsourced service for SSREPs. The method encompasses an integrated set of supply advisory, transaction management, and business reporting services that provide an SSREP with strategic and implementation support on an outsourced basis.

In one aspect of the invention, the business process outsourcing service provides a method for enabling a business organization to become a self-serving retail electricity provider in a deregulated market. The business process outsourcing service registers the business organization as a retail energy provider with a public utility commission. The outsourcing service then assists the business to qualify as a scheduling entity with an independent system operator (ISO). The outsourcing service then establishes the business as a bilateral trading partner with one or more wholesale energy merchants.

In another aspect of the invention, the business process outsourcing service provides a method for assisting a self-serving retail electricity provider in energy purchasing and risk management decisions. A zonal load requirement is first forecast for the SSREP. The zonal load requirement is analyzed to develop a volumetric energy purchasing strategy that meets or exceeds the zonal load requirement for the SSREP. A supply control strategy is established for the SSREP. An energy price forecasting analysis is then performed and the results are compared with supply offers from wholesale energy merchants. The business process outsourcing service then brokers a bilateral transaction for energy supply between the SSREP and the wholesale energy merchant.

In another aspect of the invention, the business process outsourcing service provides a method for assisting a self-serving energy provider to manage a plurality of transactions with an ISO and a transmission and distribution service provider (TDSP). The outsourcing service submits a request to the ISO and the TDSP to switch a metered account for the business organization to the SSREP that has been established. The daily load forecast for the SSREP is updated and compared with a wholesale energy purchase commitment to identify periods of imbalance between energy supply and consumption demand. A daily schedule of forecasted sub-hourly load and purchase and sale commitments is submitted to the ISO. The outsourcing service receives and processes invoices from various market participants. It also generates financial settlement reports for the SSREP.

### BRIEF DESCRIPTION OF DRAWINGS

The invention is better understood by reading the following detailed description of the invention in conjunction with the accompanying drawings.

FIG. 1 illustrates an overview of the functions performed by the outsourcing service provider in accordance with an exemplary embodiment of the invention.

FIG. 2 illustrates the process for enabling a entity to become a self-serving retail electricity provider in accordance with an exemplary embodiment of the invention.

FIG. 3 illustrates the processing logic for calculating a deterministic load forecast that is derived from a collection of historical load data for a customer, a normalization for weather effects, and adjustments for other factors affecting consumption.

FIG. 4 illustrates the processing logic for estimating short-term stochastic parameters.

FIG. 5 illustrates the processing logic for simulating marginal clearing prices and hourly customer load using stochastic modeling of prices and loads.

FIG. 6 illustrates the processing logic for the price forecasting automation system (PFAS) in accordance with an exemplary embodiment of the invention.

FIGS. 7A-7B illustrate an exemplary presentation of the load forecast information for a weekday and weekend for a given month.

FIGS. 8A-8B illustrate tabular and graphical displays of the price forecast data with forward market prices presented as a point of comparison.

FIG. 9 illustrates an exemplary presentation of the relative frequency of forecasted energy costs in a histogram format.

FIG. 10 illustrates an exemplary presentation of a price duration analysis for a customer over a calendar year.

FIG. 11 illustrates execution support services provided to a self-serving retail electricity provider in accordance with an exemplary embodiment of the invention.

FIGS. 12-15 illustrate exemplary reports provided to a self-serving retail electricity provider in accordance with an exemplary embodiment of the invention.

### DETAILED DESCRIPTION OF THE INVENTION

The following description of the invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances and are a part of the present invention. Thus, the following description is provided as illustrative of the principles of the present invention and not in limitation thereof, since the scope of the present invention is defined by the claims.

The following definition of terms used in this description are provided for ease of reference by the reader:

Ancillary Services—those services necessary to support the transmission of energy from resources to loads while maintaining reliable operation of a transmission provider's transmission systems in accordance with good utility practice.

Baseload Electricity—Electricity energy supplied at a consistent MW volume over a defined period of time.

Bilateral Energy Contract—a contract for electricity supply that is negotiated between two market participants.

Deterministic Forecast—represents an expected value for a variable such as electricity prices, customer load, or energy costs.

Distribution Loss Factors—a multiple of the electric energy loss in the distribution system. The losses consist of transmission, transformation, and distribution losses between supply sources and delivery points.

Electronic Data Interface (EDI)—a system used by market participants to transmit data electronically using an established market protocol.

ERCOT—Electricity Reliability Council of Texas, Inc., an ISO.

Independent System Operator (ISO)—a not-for-profit entity established to manage and oversee power market operations, including processing of power schedules, forecasting of system load, dispatch of generation resources, procurement of system reliability services, and other wholesale market services.

Load—the amount of electrical power delivered at any specified point or points on a system.

Load Profile—a representation of the energy usage of a group of metered locations, showing the demand variation on an hourly or sub-hourly basis.

Load Serving Entity (LSE)—an entity that provides electric service to customers and wholesale customers; load serving entities include retail electric providers, competitive retailers, and non-opt in entities that serve loads.

Market Clearing Price for Energy (MCP)—the highest price associated with a congestion zone for a settlement interval for balancing energy deployed during the settlement interval. Sometimes also known as the balancing energy price or the spot price.

Monte Carlo Simulation—analytical method that generates random values for uncertain variables to assess risk probabilities through multiple iterations of a mathematical model.

On-Peak Energy—electrical energy supplied during a period of relatively high system demands as specified by the supplier.

Price Duration Analysis—analysis that determines how many times prices fall in defined price bins on an annual basis. Used as a valuation tool to calculate demand-response programs and capital investment opportunities.

Price Forecasting Automation System (PFAS)—the electronic system, methods, processes and data presentment formats that are used by patent applicant to support SSREPs with strategic and analytical services. The PFAS is described further in the co-pending and commonly assigned patent application “System and Method for Energy Price Forecasting Automation,” U.S. patent application Ser. No. 10/826,422, filed on Apr. 16, 2004.

Public Utility Commission (PUC)—a state PUC is generally responsible for overseeing retail power market transactions. Sometimes known as a Public Service Commission, State Corporation Commission, or other monitor.

Regulated Charges—charges governed by state Public Utility Commission or other entity as adders to basic supply charge (e.g., customer transition charge, transmission and distribution, system benefit).

Retail Electricity Provider (REP)—an entity that sells electric energy to retail customers in a deregulated state. A commercial REP is such an entity that sells electric power to unrelated third parties and manages all required market transactions.

Scheduling Entity—a market participant that is qualified by an ISO to submit schedules of bilateral energy purchases, expected load requirements, and energy and ancillary services bids, and to settle payments with the ISO. Commonly known as a Qualified Scheduling Entity (QSE) in the ERCOT market.

Self-Serve REP (SSREP)—an entity established to supply retail electricity to its own, affiliated locations.

Stochastic Forecast—A probabilistic forecast developed through Monte Carlo simulation of energy prices and a customer load profile.

Transmission and/or Distribution Service Provider (TDSP)—an entity that owns, or operates for compensation in the state, equipment or facilities to transmit and/or distribute electricity, and whose rates for transmission service, distribution service, or both is set by a governmental authority.

Wholesale Energy Merchant—an entity that markets electricity in the wholesale market, either by selling the output of its generating facilities or trading energy products.

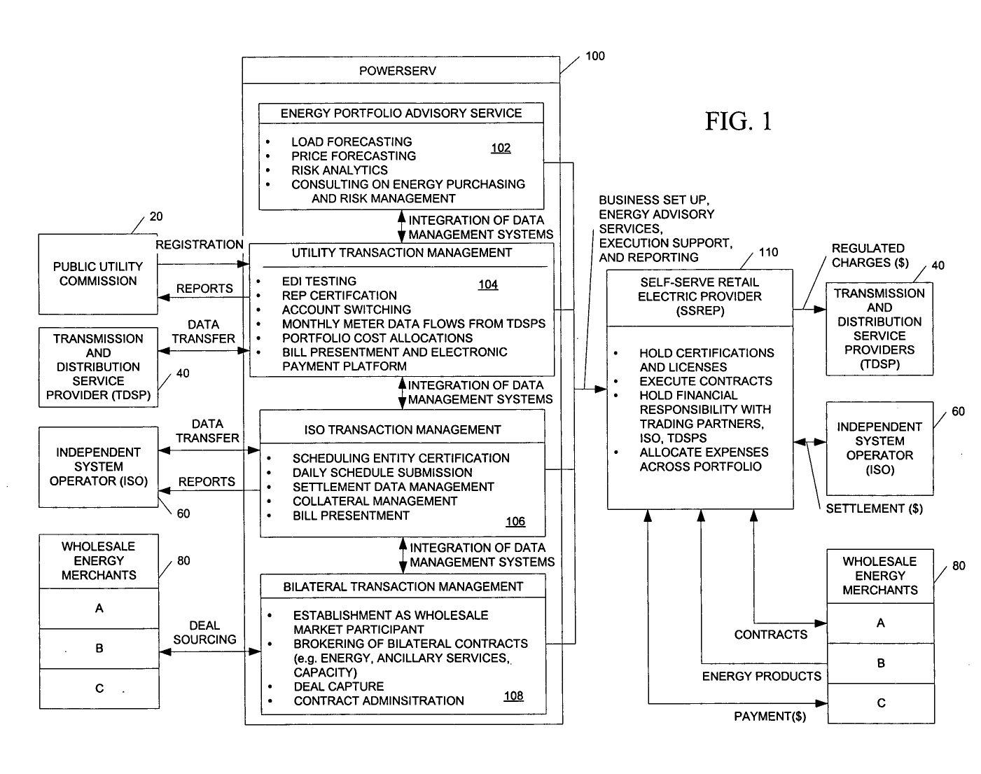

The present invention enables an SSREP to efficiently perform these functions via the support of a single, outsourced business relationship. The invention specifically manages the commercial interactions and electronic information exchange between the SSREP and the key market participants (the PUC, the TDSPs, the ISO, and Wholesale Energy Merchants). Also included in the service is a set of energy advisory methods such as load forecasting, price forecasting, risk analytics and consulting on energy purchasing and risk management for the SSREP. The integrated methodology performed for an end-user customer facilitates its ability to become qualified as an SSREP and to manage the required operations. FIG. 1 provides an overview of the integrated set of services provided.

As shown in FIG. 1, the PowerServ® outsourcing service (block 100) includes a strategic advisory service (block 102), a utility transaction management function (block 104), an ISO transaction management function (block 106) and a bilateral transaction management function (block 108). The PowerServ® service, referred to more generally herein as a business process outsourcing service interfaces with, and manages electronic information exchange among, the SSREP (block 110), transmission and distribution service providers (block 40), independent system operator (block 60), and wholesale energy merchants (block 80) (also referred to as bilateral trading partners). Strategic advisory service (block 102) further includes several analytical tools such as load forecasting, price forecasting, and risk analysis described more fully herein. The business process outsourcing service provides recommendations and support to the SSREP (block 110) in brokering contracts with wholesale energy merchants (block 80) for energy products, and handling settlement for the SSREP (block 110) with the wholesale energy merchants (block 80), independent system operator (block 60) and transmission and distribution service providers (block 40).

The invention provides three main categories of services including: business set-up and compliance services; energy portfolio advisory services; and execution support services.

Business Set-Up and Compliance Services

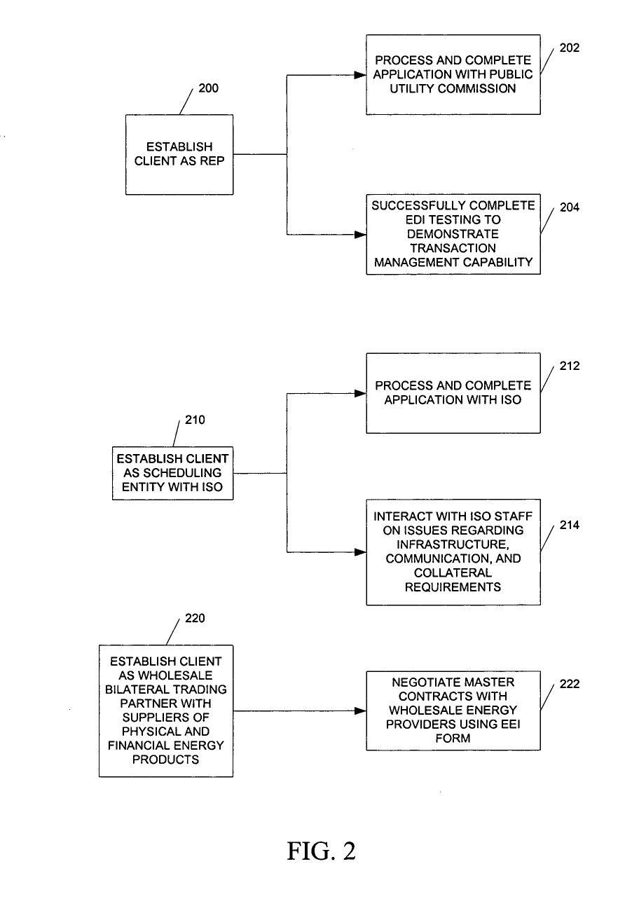

FIG. 2 illustrates the steps for enabling an entity to become an SSREP, in adherence with regulatory and commercial guidelines within a given market.

First, the outsourcing service provider manages the process (block 200) for the SSREP to become registered as an REP. This process includes management of application filings with the Public Utility Commission of the state (block 202) and successful completion of electronic data interface (EDI) testing to demonstrate the capability to manage data and financial transactions with TDSPs and the ISO (204).

The outsourcing service provider also assists the SSREP in becoming qualified as a Scheduling Entity (block 210), which is responsible for electronically submitting to the ISO sub-hourly forecasts of its load requirements and bilateral wholesale purchases, aggregated by market zonal area. Schedule information is used by the ISO to determine the degree of imbalance between supply and demand, and to take steps to reduce such imbalances through dispatching of generation and procurement of ancillary services. The outsourcing service provider assists the SSREP in becoming a Scheduling Entity with the ISO by completing application forms (block 212); demonstrating EDI capability with the ISO to send such schedules and receive financial settlement information; and establishing a collateral requirement (block 214) that the SSREP will maintain with the ISO. The SSREP as a Scheduling Entity is financially responsible to the ISO for any amounts owed due to balancing/spot market purchases, ancillary service obligations, and ISO administrative fees. In certain markets, the outsourcing service provider may arrange for the SSREP to instead join a Scheduling Entity that provides such services to its members and is financially responsible to the ISO. In this case, the outsourcing service provider assists the SSREP in negotiating terms and conditions of service.

The outsourcing service provider also establishes the SSREP as a bilateral trading partner with Wholesale Energy Merchants (block 220). Utilizing the Edison Electricity Institute (EEI) form contract as a basis, master agreements are negotiated with energy suppliers on behalf of the SSREP (block 222). These may then be utilized for any subsequent energy purchase or sale transactions, which are arranged and brokered on the SSREP's behalf.

Energy Portfolio Advisory Services

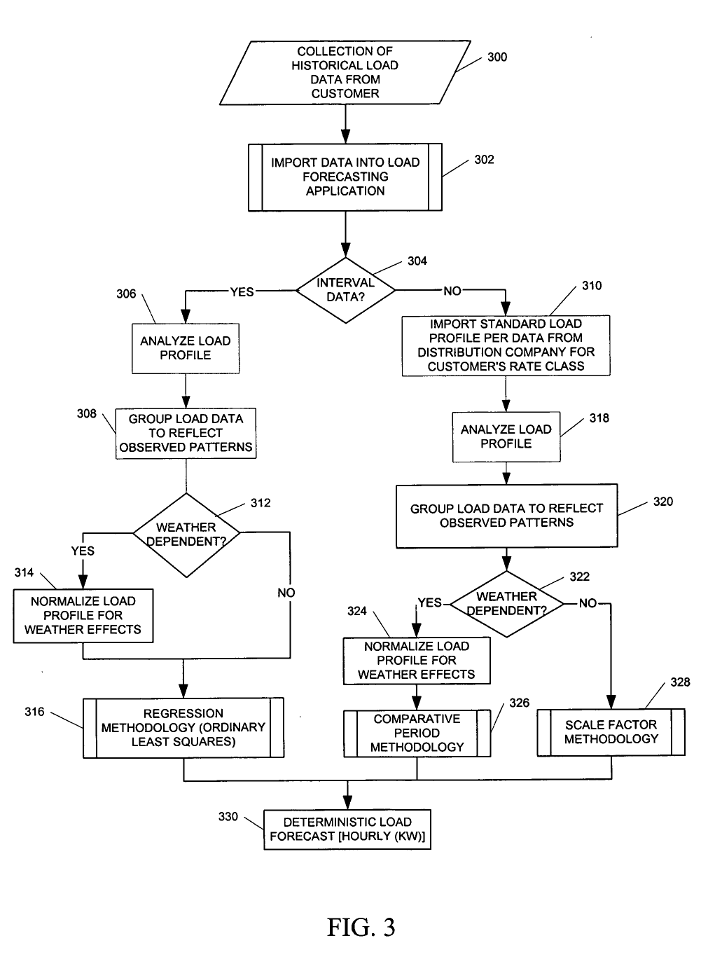

FIGS. 3-6 illustrate the strategic and analytical advisory services that are provided to the SSREP to support decision-making in areas of energy purchasing and risk management. These services are supported by a Price Forecasting Automation System (PFAS), which is described further in the co-pending and commonly assigned patent application “System and Method for Energy Price Forecasting Automation,” U.S. patent application Ser. No. 10/826,422, filed on Apr. 16, 2004. Load forecasting and risk simulation software is used to generate numerous forecast iterations of hourly or sub-hourly customer loads and wholesale prices. The PFAS then processes such output to generate information that is used for the advisory services described herein. These procedures are described below.

A. Development of Stochastic Price and Load Forecast Output

The business process outsourcing provider utilizes stochastic (iterative) forecasts of prices and loads. These are developed by 1) generating a deterministic load forecast; 2) estimating stochastic parameters for use in Monte Carlo simulation; 3) performing the Monte Carlo simulation. Each of these steps is discussed in detail below.

A.1. Generation of a Deterministic Load Forecast—FIG. 3 illustrates the methodology for calculating a deterministic (expected case) load forecast for the SSREP, which is the first step in the modeling process. The method starts with collection of historical customer load data as indicated in block 300. Customer load data is imported into an application, such as the Load Forecasting application available from Henwood Energy Services, that forecasts load consumption based on historical demand curve, peak demand, and normalization of weather and other factors. This step is indicated in block 302. A test is then performed in decision block 304 to determine if the historical customer load data is in the form of monthly or interval kWh measures. If the data is in interval form, the “yes” path is followed. The customer load profile is analyzed in block 306. The customer load data is grouped to reflect observed patterns as indicated in logic block 308. Next, a test is made in decision block 312 to determine if the data is weather dependent. If the data is weather dependent, then the customer load profile is normalized for weather effects as indicated in logic block 314. Regardless of the interval data being weather dependent or not, the next step in the process is to perform a regression methodology using ordinary least squares, as indicated in logic block 316. The output from the regression analysis is a deterministic load forecast on an hourly basis as indicated in logic block 330. If in decision block 304, the data is not in interval form, the “no” path is followed. A standard load profile for the customer data is imported from the distribution company for the customer's rate class as indicated in logic block 310. The customer load profile is analyzed in block 318. The customer load data is grouped to reflect observed patterns as indicated in logic block 320. A test is made in decision block 322 for weather dependency. If weather dependent, the load profile is normalized for weather effects in logic block 324. Following normalization of the load profile for weather effects, a comparative period methodology is applied to the load profile in logic block 326. The output from the comparative period methodology is the deterministic load forecast on an hourly basis as indicated in logic block 330. If the load data is not weather dependent, then a scale factor methodology is applied to the load profile in logic block 328 to arrive at a deterministic load forecast in logic block 330. The following paragraphs provide further clarification on the logic blocks depicted in FIG. 3.

After collecting load data from the client (block 300) and importing the data into the load forecasting application (block 302), the data is graphed to view: (1) seasonal effects, (2) day-types, (3) time-of-use patterns, and (4) holiday effects. Each of these represent characteristics specific to the end-customer. For example, the typical profile of a commercial retailer would have a seasonal load pattern of peak consumption in the summer (due to air conditioning loads) and lowest usage during the spring and autumn. The store hours may run from 8 AM-8 PM and not require much energy usage after closing. Each of these characteristics needs to be accounted for in the forecast for a more accurate picture of where the consumption could trend in the future. The analysis of load profile and grouping of the load to reflect observed patterns are represented by blocks 306, 308 on the “yes” path and by blocks 318, 320 on the “no” path out of decision block 304.

Understanding end-user consumption patterns is important to determining what type of load forecasting model to use. The three factors that have the most influence on consumption are econometric measures, weather, and operational measures. Examples of econometric measures are population, employment, income and gross national product (GNP). Examples of operational measures are production scheduling for industrial end users and store hours for commercial end users. For some customers, weather greatly influences load consumption by shifting the demand curve up or down by a percentage change in temperature. Therefore, for weather dependent loads, the load profile is normalized by making adjustments for historical weather patterns (blocks 314, 324). Non-weather dependent loads (e.g., industrial loads) may not be adjusted for weather effects, but can be normalized based on inputs from the customer about production scheduling and other variables.

One of three different methodologies is used in developing the deterministic load forecast (block 330). These include scale factor methodology (block 328), comparative period methodology (block 326), and regression methodology (block 316). In scale factor methodology (block 328), scale factors reflect the percentage difference of a particular customer's consumption from the generalized load shape for that customer's class. Scale factors are calculated and used for forecasting in a commercially available application that forecasts load consumption. Comparative period methodology (block 326) includes temperature adjustments and seasonally specific elasticities for load responses to heating and cooling degree-days, and calendar adjustments. Regression-based forecasting (block 316) is used to develop independent forecasting equations that reflect weather, processes or other statistically relevant variables.

A.2. Estimation of Stochastic Parameters

The stochastic modeling process involves allowing forecasts to deviate from deterministic values according to a set of statistical parameters. The effect is to simulate variability and uncertainty that inherently exists in complex power markets and customer load profiles, and to yield stochastic (iterative) forecast analyses that reflect various potential outcomes. A risk simulation model, such as the RiskSym application available from Henwood Energy Services, can be used to perform the calculations needed to create Monte Carlo simulation results for stochastic analyses of hourly energy prices and load consumption.

In order to run the stochastic model in the risk simulation application, a set of short-term stochastic parameters must be calculated. To that effect, the present invention derives volatility of and correlations between historical prices and customer load, on a seasonal basis, to establish parameters that are used for the stochastic forecasting process.

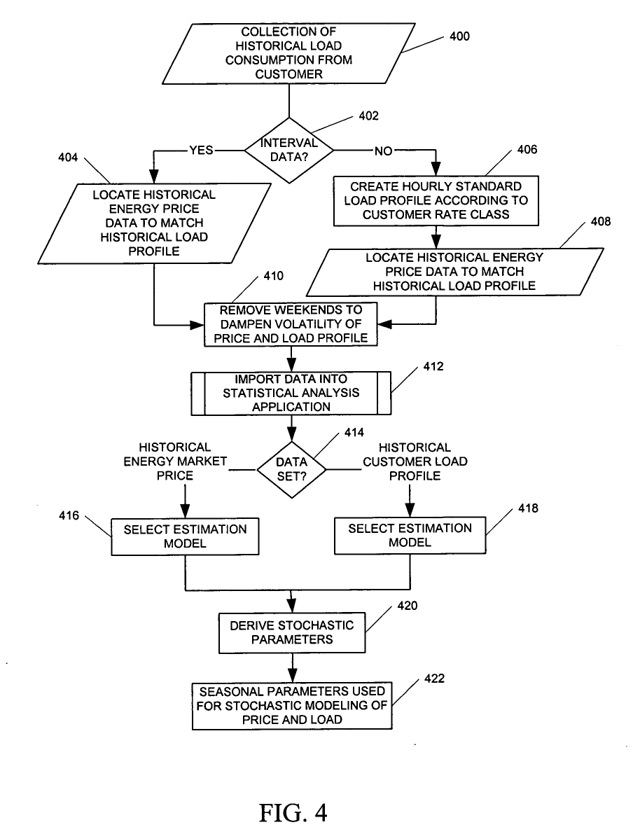

FIG. 4 illustrates processing logic for estimating short-term stochastic parameters. Processing starts in block 400 with collection of historical energy consumption data from the customer. A test is made in decision block 402 to determine if the data is in interval format. If it is, the “yes” path is followed and historical energy price data is located to match with the historical load profile as indicated in block 404. Weekend data is then removed to dampen the volatility of the price and load profile as indicated in logic block 410. If the historical consumption data is not in interval format, the “no” path is followed and an hourly standard load profile is created according to the customer rate class as indicated in logic block 406. Historical energy price data is then located to match historical load profile data as indicated in logic block 408. This is followed by removal of weekend data to dampen volatility of price and load profile as indicated in logic block 410. Next, the data is imported into a statistical analysis application as indicated in logic block 412. Next, in decision block 414, a test is made to determine the type of data set that has been imported into the statistical analysis application. For historical energy market price data, an estimation model is selected as indicated in logic block 416. For historical customer load profile data, the estimation model is selected in logic block 418. From either logic block 416 or 418, processing continues with derivation of the stochastic parameters for the selected estimation model as indicated in logic block 420. This is followed in logic block 422 with determination of seasonal parameters for stochastic modeling of price and load. Various logic blocks are described in greater detail in the following paragraphs.

Essentially, there is a four-step process to establish short-term stochastic parameters.

Step 1: Collect Historical Load Data and Generate an Hourly Historical Load Profile (Block 400)
To the extent that customer data is in monthly (kWh) format, the data has to be transformed to an hourly format by matching the customer load profile with the utility's standard load profile of that customer's class (block 406). This process involves calculating the ratio between the monthly consumption of standard load profile and customer's actual consumption. The process then multiplies each interval by the ratio to approximate hourly consumption (KW format). If the data is in interval (KW) format (decision block 402), no such conversion is necessary.

Step 2: Pull Historical Hourly Price Data from Publicly Available Sources that Matches Time Frame of Load Data (Blocks 404, 408, 410)
In order to effectively correlate price and load, the estimation process uses actual market prices that occurred during the same time period as the load data. These data sets are then used to develop seasonal correlations between prices and loads. For weather dependent loads, this is particularly important since higher consumption will typically occur during periods with high prices. If historical electricity price data is not available, other available information such as fuel prices is combined with knowledge of the supply curve and generation fuel mix to derive a compatible price index that can be correlated with customer load. For example, in markets where natural gas tends to be the fuel for price-setting plants, natural gas prices may be used as the index with which the stochastic parameters are derived.

Step 3: Import Both Data Sets into a Statistical Analysis Application that Performs a Linear Regression and other Statistical Analytics (Block 412)

Step 4: Select Appropriate Estimation Model (Blocks 416, 418)
Using a defined process, select the estimation model that will most accurately reflect historical behavior of both load and energy prices. The stochastic estimation model selected is the one that most accurately reflects historical behavior of a customer's load and energy prices. This step involves the following processes:
(a) Review Historical Price and Load Data
The historical price and load data are graphed to view trends by season and to capture periods of high volatility and/or price events.
(b) Select Statistical Model (Blocks 416, 418, 420)
The resulting shape of the distribution of values is then used to determine an appropriate statistical model for stochastic modeling. It is widely accepted in the industry that energy commodity prices do not fit into normal distribution models. Most customer loads also are not normally distributed. Lognormal distributions are generally a better representation for both price and load, except for extreme events in which spikes or jumps occur. In that case, Markov Regime Switching (MRS) models are more appropriate. The advantage that an MRS model has over a lognormal model is its ability to simulate a price distribution that includes infrequent but large upward price spikes by estimating distinct mean and volatility parameters for both a low price state and a high price state. Thus, the lognormal and MRS models are most commonly utilized.
(c) Test Results
Once a model has been selected, it is tested against other estimation models and stressed (e.g., determine impact of a shift change or gas spike) to ensure correct correlative values, volatility, and mean-reversion.

The statistical analysis linear regression model calculates (block 422) the following short-term stochastic parameters: (a) seasonal short-run mean-reversion and volatility parameters; and (b) correlations between the seasonal regression residuals of historical load and historical prices. In other words, a set of statistical values are developed representing: (1) a seasonally-based standard deviation and mean-reversion of historical market prices and customer load, and (2) a seasonally-based correlation between the historical market prices and customer load.

A.3. Monte Carlo Simulation Process

The general simulation model used is a two-factor lognormal mean-reverting stochastic model. One factor represents short-term deviation around an average or equilibrium level. The second factor represents long-term uncertainty of the equilibrium and captures random walk. The present invention provides a defined process for developing short-term stochastic parameters as described below.

The term mean-reversion implies that a variable (whether price or load) oscillates around an equilibrium level. Every time the stochastic term gives the variable a push away from the equilibrium, the deterministic term will act in such a way that the variable will start heading back to the equilibrium. Historically, energy prices have exhibited this type of mean-reversion behavior.

Key features of the model include:
a lognormal electricity price and load distribution is assumed;
an allowance of seasonal varying volatility and correlation parameters to handle cyclical price and consumption patterns of energy commodities.

The simulation model is run for a simulated time period up to 20 years. This involves hourly Monte Carlo random draws for electricity prices and load consumption and may be performed for 100 or more iterations over the simulation time frame.

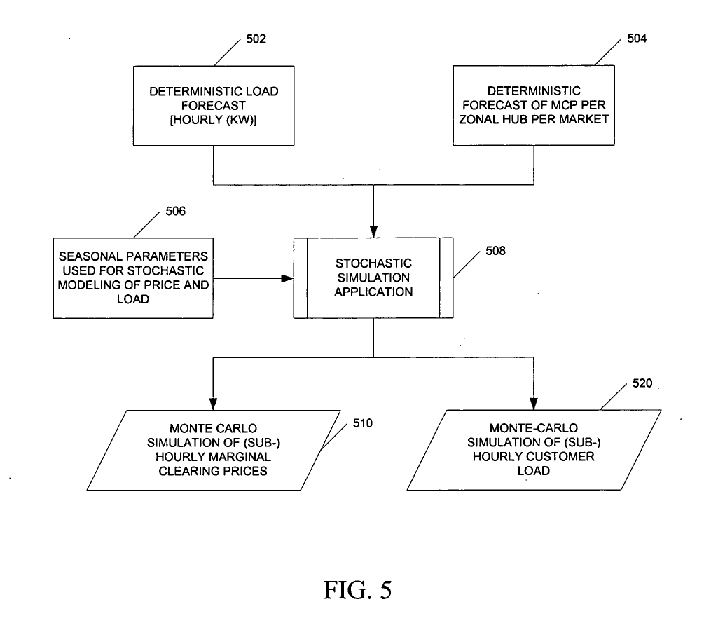

The deterministic load forecast on an hourly basis that is produced from the processing logic of FIG. 3 (logic block 330) and shown at block 502 in FIG. 5 is one of the inputs into a stochastic simulation application (block 508) that performs Monte Carlo simulations of marginal clearing prices and hourly customer load. A second input into the stochastic simulation application is a deterministic forecast of market clearing prices per zonal hub per market, as indicated in block 504. The seasonal parameters used for stochastic modeling of price and load that is output in logic block 422 of FIG. 4 and represented in logic block 506 is an additional input into the stochastic simulation application. Operation of the stochastic simulation application then results in Monte Carlo simulation results of marginal clearing prices as indicated in block 510 and hourly customer load as indicated in block 520. Further details on the processing logic of FIG. 5 is described in the following paragraphs.

As shown in FIG. 5, a deterministic forecast of market energy prices (block 504) and a deterministic forecast of the customers' consumption (block 502) (as described in the Deterministic Load Forecasting section) are inputs into the stochastic simulation application (block 508). The market energy price forecast (block 504) comes from a fundamental analysis performed by looking at variables such as power plant costs, fuel prices, maintenance schedules, demand forecasts and transmission constraints. These variables are stochastically modeled to create an expected view of prices in specific markets.

Output from the stochastic simulation application yields stochastically modeled hourly load (block 520) and wholesale price (block 510) data for the number of iterations performed. Exemplary outputs are shown in Tables 1 and 2, below. Table 1 shows the simulated energy prices on an hourly basis over a calendar year, with “i” iterations being performed to simulate each hour's energy price forecast. Table 2 shows the simulated load forecast on an hourly basis over a calendar year with “i” iterations being performed to simulate each hour's load forecast.

TABLE 1
Monte-Carlo Simulated Energy Price Forecast ($/MWh)

| | | **Time | | Iteration | |
|---|---|---|---|---|---|
| Year | Date | Interval j | Iteration 1 | 2 . . . | *Iteration i |
| 2004 | Jan. 1, 2004 | 1 | 20.23 | 22.69 | 18.36 |
| 2004 | Jan. 1, 2004 | 2 | 20.45 | 23.14 | 19.01 |
| 2004 | Jan. 1, 2004 | . | 20.64 | 23.42 | 19.81 |
| | | . | | | |
| | | . | | | |
| 2004 | Jan. 1, 2004 | 24 | 35.15 | 32.25 | 38.62 |
| . | . | . | . | . | . |
| . | . | . | . | . | . |
| . | . | . | . | . | . |
| 2004 | Dec. 31, 2004 | 24 | 38.22 | 36.68 | 37.69 |

TABLE 2
Monte-Carlo Simulated Load Forecast (KW)

| | | **Time | | | |
|---|---|---|---|---|---|
| Year | Date | Interval j | Iteration 1 | Iteration 2 | *Iteration i |
| 2004 | Jan. 1, 2004 | 1 | 1021.20 | 1108.25 | 1365.68 |
| 2004 | Jan. 1, 2004 | 2 | 1532.21 | 1000.65 | 1236.45 |
| 2004 | Jan. 1, 2004 | . | 1601.83 | 1263.75 | 1250.34 |
| | | . | | | |
| | | . | | | |
| 2004 | Jan. 1, 2004 | 24 | 1109.36 | 1230.05 | 1298.62 |
| . | . | . | . | . | . |
| . | . | . | . | . | . |
| . | . | . | . | . | . |
| 2004 | Dec. 31, 2004 | 24 | 1025.69 | 1311.58 | 1241.21 |

*i = iteration
**j = time interval (e.g., 15 min. or hourly)

B. Data Processing and Presentment of Forecast Information

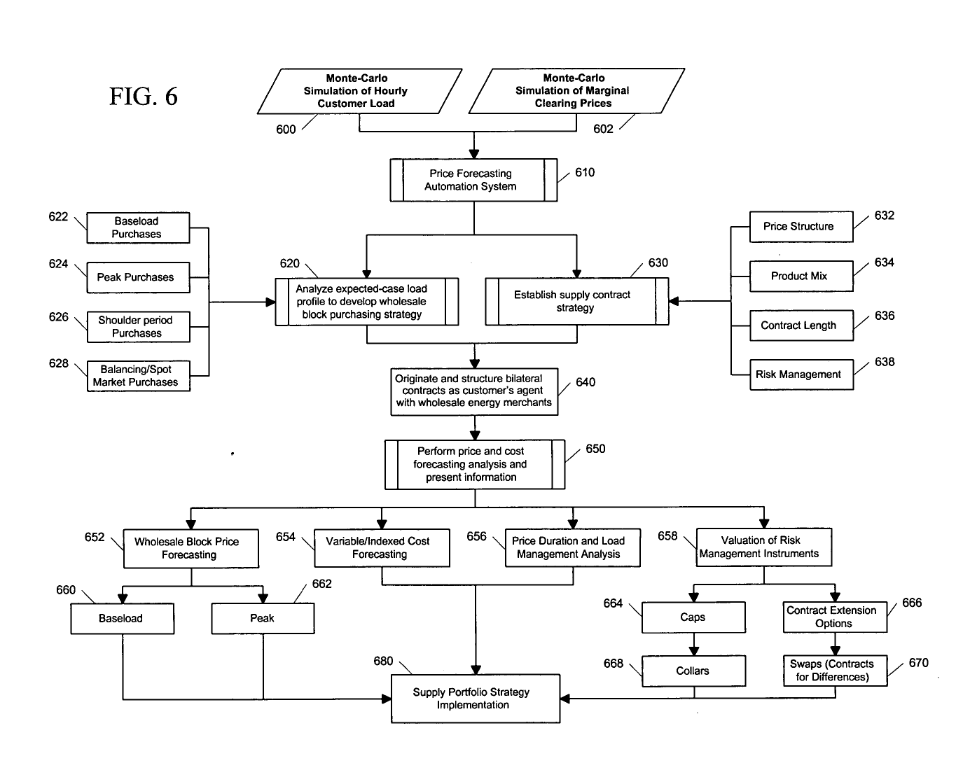

FIG. 6 illustrates the processing logic for the PFAS (block 610), which takes simulation results for marginal clearing price and (sub-)hourly customer load (block 600, 602) and is utilized for several of the Energy Portfolio Advisory Services described herein, including the customer load forecasting and volumetric analysis; forecasting of prices for specific wholesale energy products; price duration analyses to value load management capability that the customer may be able to realize as SSREP, and valuation of financial risk management instruments. These uses of the PFAS are discussed in the corresponding sections below.

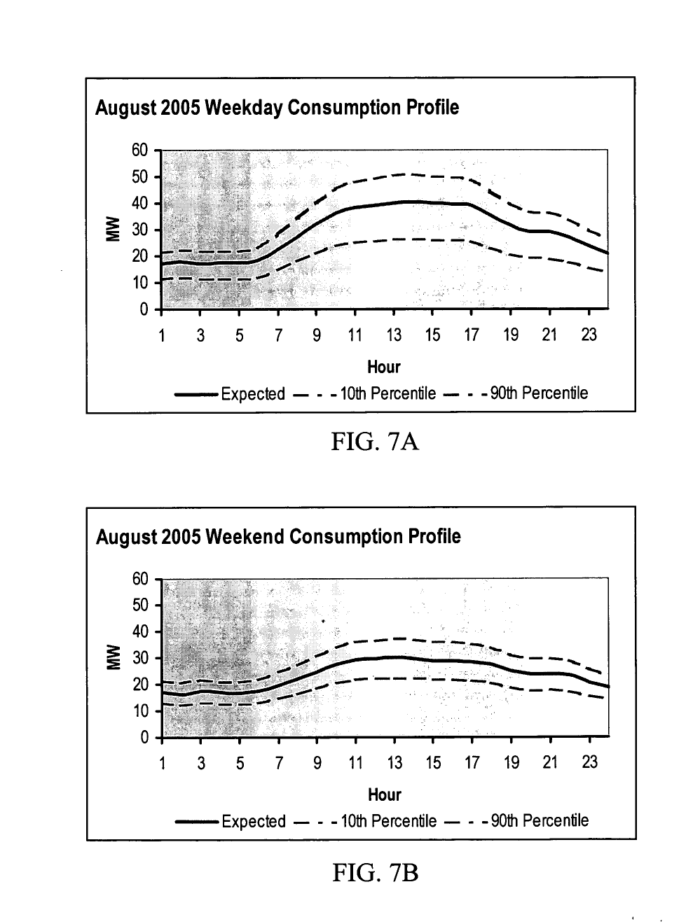

Customer Load Analysis (Block 620)—The PFAS creates a forecast analysis of the SSREP's load requirements by ISO zone. This is done via automated processes that sort the load forecast outcomes by iteration and user-specified time periods. FIGS. 7A-7B illustrate a sample presentation of the forecast information wherein the load profile is forecasted for a weekday and weekend for a given month. The PFAS captures data for an expected case outcome, as well as a 10^{th} percentile and 90^{th} percentile. Data may be presented in a line graph or tabular format. The load forecasts from the PFAS model are a critical input into energy purchasing decisions for the SSREP, as they are used to determine the electricity volumes to be purchased.

The forecasted load profile is then analyzed to develop a wholesale electricity purchasing strategy (block 620). Wholesale electricity typically trades in blocks, whereby an SSREP can buy a fixed amount of power (in megawatts) over various monthly and intraday timeframes. The outsourcing service provider advises the SSREP on a volumetric purchasing strategy that meets the expected zonal load requirements. For example, through analysis of load profile information, the outsourcing service provider establishes a suitable monthly volume of baseload power that can be purchased to cover the SSREP's minimum expected electricity consumption. This baseload purchase (block 622) can be supplemented with peak period (block 624) or shoulder period purchases (block 626) that will meet load requirements during hours of higher demand, such as the period from late morning to early evening. The spot or balancing market (block 628) may be used to purchase the balance of the SSREP's load requirements or to sell back those volumes that are not required during certain hours.

Establish Supply Contract Strategy (Block 630)—The outsourcing service provider also advises the SSREP on other purchasing-related matters, such as pricing structure (block 632), product mix (block 634), contract lengths (block 636), and risk management (block 638). The outsourcing service provider utilizes the energy price forecasting and risk analytics software and systems described in the above-referenced patent application to originate and structure bilateral contracts as the customer's agent with Wholesale Energy Merchants (block 640).

C. Price and Cost Forecasting Analysis (Block 650)

The outsourced service provider utilizes PFAS to perform analyses that support the SSREP in making energy purchasing and risk management decisions. Four of the core forecast analyses (wholesale block prices, variable indexed costs, price duration and load management analyses, and valuation of risk management instruments) are discussed below.

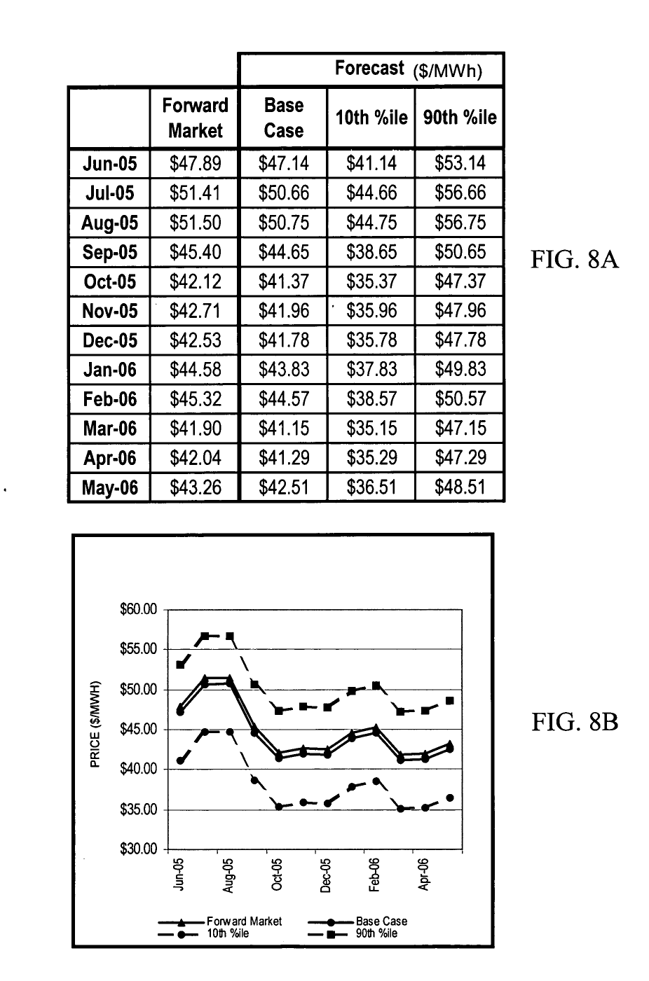

Wholesale Block Price Forecasting (Block 652)—The PFAS is used to provide probabilistic forecasts of prices for various wholesale block energy products (e.g., baseload power and peak power). The outsourcing service provider first chooses the time period for analysis (e.g., peak hours for each of the next 12 months). The PFAS is then used to capture the forecasted price data for the chosen time period, average the hourly prices for each iteration, and sort the iterations by the average hourly price outcome to derive expected-case and percentile outcomes. FIGS. 8A-8B illustrates how the forecast data may be displayed, with forward market prices also presented as a point of comparison.

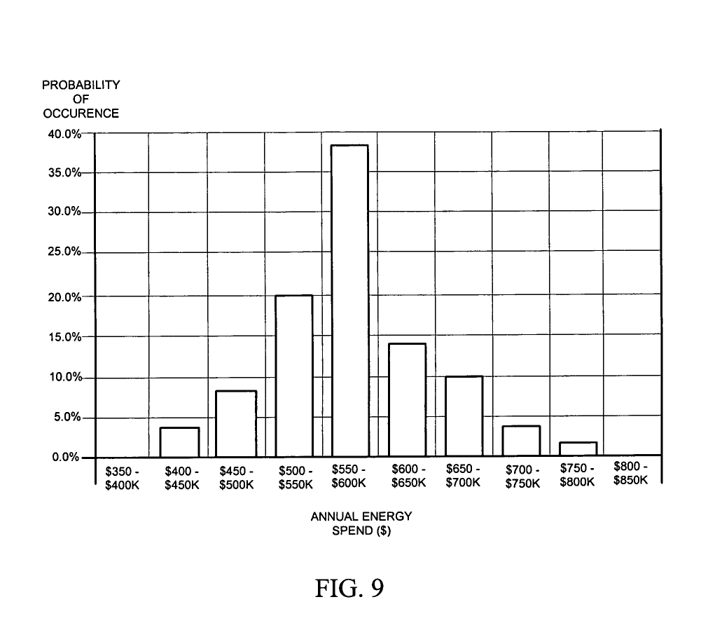

Variable Indexed Cost Forecasting (Block 654)—The outsourcing service provider also forecasts the costs of variable-priced indexed power for the SSREP. As discussed above, the SSREP may decide that it will purchase blocks of wholesale power for a portion of its load while relying on the spot or balancing market for the remainder of its requirements. The outsourcing service provider utilizes the PFAS to evaluate the potential cost outcomes for the indexed portion of the SSREP's portfolio by performing the following automated calculations:
(a) calculate the indexed power volume for each hour by subtracting the contracted power for such hour from the forecasted load;
(b) calculate the cost of indexed power for each hour by multiplying the indexed power volume by the forecasted price for such hour;
(c) calculate the total cost of indexed power for each iteration by summing the results obtained in (b) for all hours during the analysis period;
(d) sort the total cost outcomes from (c) to present the probability of costs being at various levels, with such information being displayed in a histogram or tabular format, as shown in FIG. 9.

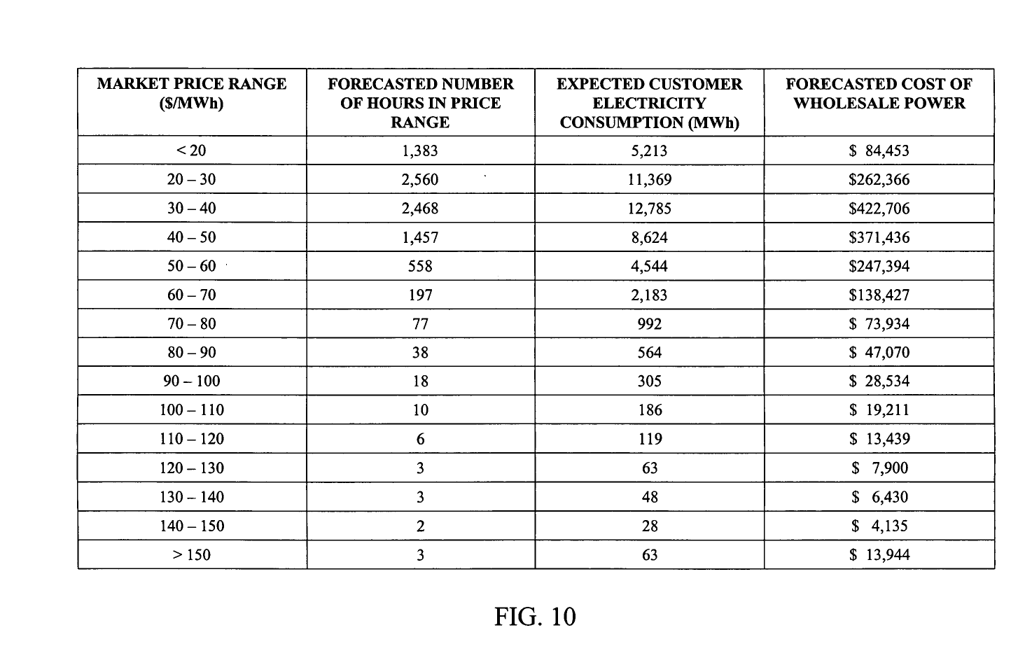

Price Duration and Load Management Analysis (Block 656)—The outsourcing service provider may also perform analyses to forecast the value of load management capability (i.e., the ability to curtail consumption of electricity during periods of high prices) and to develop a supply and operational strategy that enables the SSREP to capture such value. Specifically, the outsourcing service provider may utilize the PFAS to perform a price duration analysis such as illustrated in FIG. 10, which displays the number of hours that prices are forecasted to be at certain levels matched with the corresponding customer load forecasted for such hours. The ability to capture high price events and the corresponding load is a valuable metric in understanding the economics of alternative pricing structures and the expected value that can be realized by curtailing load or exporting power during periods of high prices. The invention derives this analysis by sorting hourly forecasts of market prices and customer loads into defined price ranges, as discussed in more detail in the co-pending application.

Valuation of Risk Management Instruments (Block 658)—The outsourcing service provider may also value financial risk management instruments that may be utilized to manage the volatility of variable indexed pricing. Typical options include (a) caps (block 664) or collars (block 668) on indexed-based (variable) contracts that have the effect of reducing the price volatility for a customer, (b) contract extension options (block 666) where the supplier (or customer) has an option to supply (receive) power at an agreed price for a defined period extending beyond the initial contract term, and (c) contracts-for-differences (swaps) where the SSREP receives a variable, indexed-based price for a stipulated energy volume and pays a fixed price for such volume (block 668). Cap products are a series of call options purchased by the SSREP. Collar products are essentially a series of call options purchased and put options sold by the SSREP that have the financial effect of enabling an SSREP to pay prices within the range of a floor (the strike price of the put) and a cap (the strike price of the call). Extension options represent a put held by the supplier (or call held by the SSREP), whereby the holder of the option has the right to extend a contract for a specified length at a stipulated strike price. Financial valuation of each of these options is dependent on strike prices, forward prices, and volatility. With the Monte-Carlo simulated results and given the strike price of both caps and floors, the PFAS values these options.

D. Supply Portfolio Strategy and Implementation (Block 680)

The outsourcing service provider uses the PFAS analyses and its market knowledge to advise the SSREP on its energy supply and risk management strategy. Specifically, the outsourcing provider provides the SSREP with forward prices available in the market for various energy products, which are compared against the forecast analyses. In addition to advising the SSREP on energy purchases, the outsourcing provider advises the SSREP on purchases of installed capacity and ancillary services, per the requirements of the ISO. The outsourcing service provider then provides implementation support by originating and structuring bilateral transactions among the SSREP and Wholesale Energy Merchants. The outsourcing service provider further advises the SSREP in its negotiations with Wholesale Energy Merchants. The outsourcing provider provides information to the SSREP that documents the forward purchase commitments that have been made and highlights when existing contractual commitments expire.

Contractual positions are monitored on an ongoing basis to ensure that the SSREP's portfolio of contracts are meeting its objectives with respect to volume and price risk exposure. Market conditions are also continually monitored to identify opportunities to buy electricity forward on what are believed to be economically advantageous terms for the SSREP.

Execution Support Services

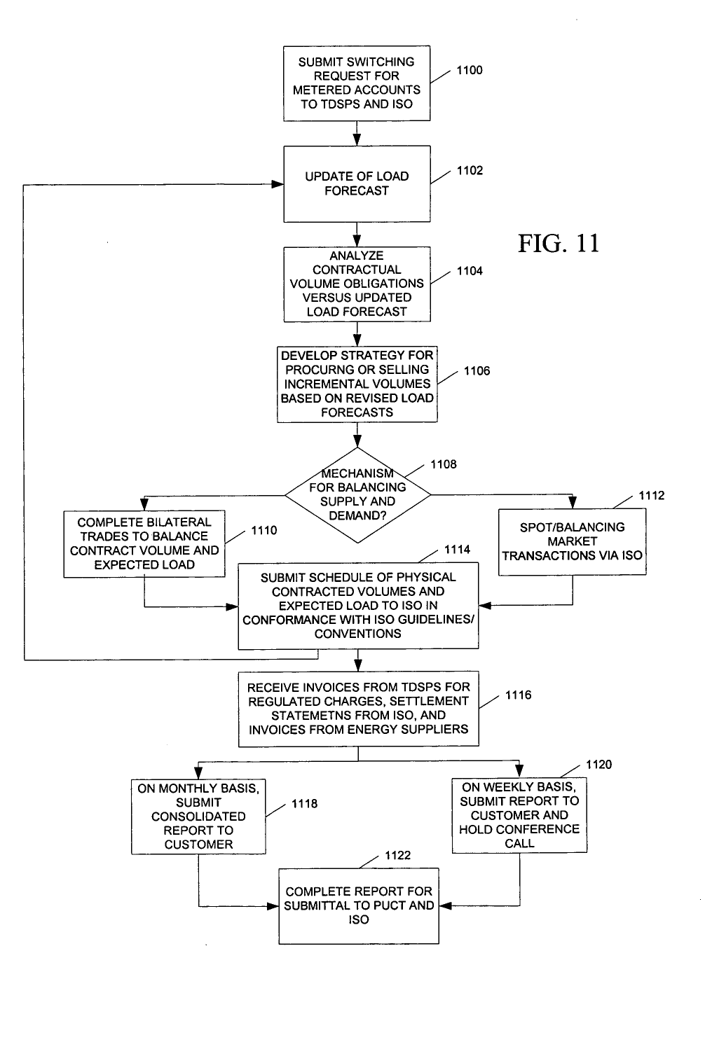

FIG. 11 illustrates the ongoing execution support services that are provided to an SSREP. This includes the management of all electronic transactions with the TDSPs and the ISO, including account switching, schedules submission, and receipt and auditing of settlement and billing data. These processes are described below.

An initial transaction managed by the outsourcing service provider is the switching of a customer's existing metered accounts to the newly established SSREP (block 1100). The required transactions are managed for the SSREP utilizing an established EDI system that provides the demonstrated capability to communicate with the TDSPs and ISO as part of the certification process previously described. This activity is performed before the date that the SSREP plans to begin supplying a set of its facilities with electric power. This activity may also be performed periodically whenever the SSREP adds new properties to its supply portfolio (e.g., as a result of an acquisition or the opening of new facilities). Once forward purchases have been made and metered accounts have been switched over, the SSREP begins serving its facilities' electricity requirements.

A second set of transactions managed by the outsourcing service provider is submission of load and power purchase schedules. Each day, the SSREP's load forecast is updated (block 1102) to account for short-term factors such as weather effects or interim changes in production schedules. The load forecast may also be periodically revised to account for longer-term factors affecting load, such as facility openings, closings, and other changes in operations. The resulting, updated load forecast is then compared with the wholesale energy contract portfolio to identify periods where the customer's purchase commitments (supply) are significantly out of balance with its expected consumption (demand) (block 1104). This imbalanced relationship (decision block 1108) may be addressed by (a) sourcing additional volumes from Wholesale Energy Merchants or marketing those volumes that are not expected to be required by the customer (block 1110); or (b) purchasing or selling back certain volumes at a market price via the ISO-administered energy imbalance (spot) market (block 1112).

Each day, schedules consisting of forecasted sub-hourly load and bilateral purchase and sale commitments are required to be submitted to the ISO. The outsourcing service provider generates and submits these schedules electronically in a manner consistent with the processes specified by the ISO and utilizing the system demonstrated during the qualification process described above (block 1114). Schedules are typically due on a day-ahead basis, with intra-day amendments required in the event of unexpected changes. This process is repeated on a daily basis.

A third set of transactions managed by the outsourcing service provider is the receipt and processing of invoice information from market participants (ISO, TDSPs, and Wholesale Energy Merchants) (block 1116). Typically on a weekly basis, the ISO will provide a settlement statement that details the amounts due from or to the SSREP for balancing (spot) market energy sales; the SSREP's share of ancillary service obligations; and ISO administration charges. These charges are reviewed and audited as part of the outsourcing service provided.

For each account, the TDSPs will provide the SSREP with a monthly statement detailing amounts owed to the TDSP for regulated services, such as transmission and distribution charges. The SSREP is required to remit payment to the TDSPs for regulated cost components of electrical service. The outsourcing service provider offers the SSREP a secure, on-line payment system to review charges and to authorize fund transfers to the TDSPs.

Wholesale Energy Merchants will invoice the SSREP for wholesale energy purchased, according to the negotiated terms and conditions contained in supply contracts. The outsourcing service provider receives this invoice information (block 1116) and includes it in financial reports delivered to the SSREP.

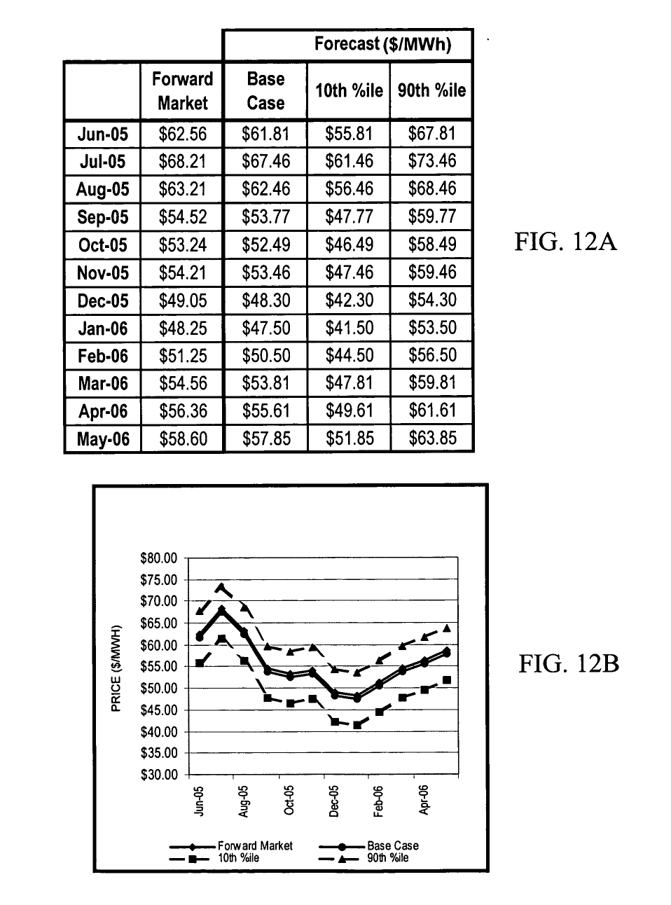

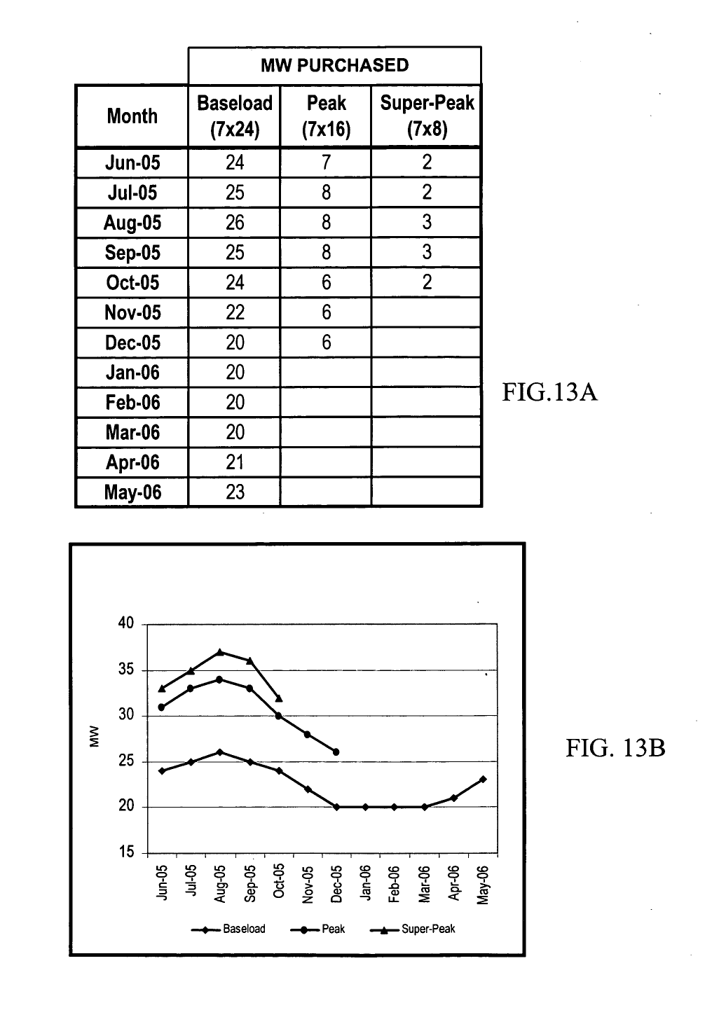

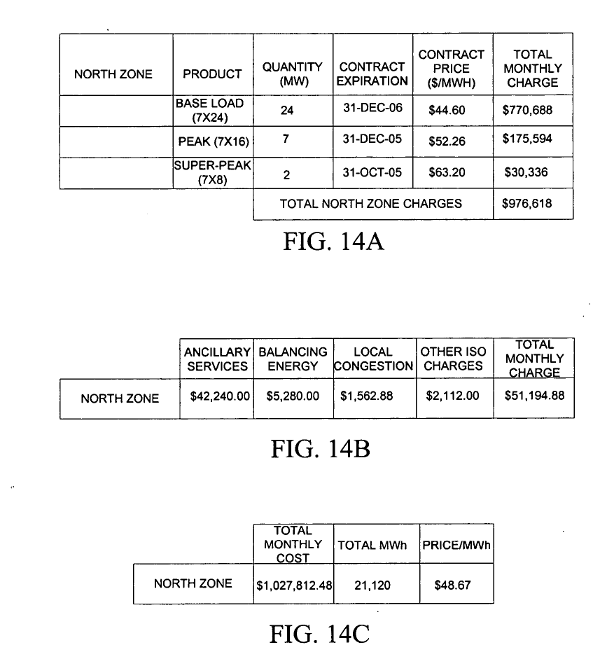

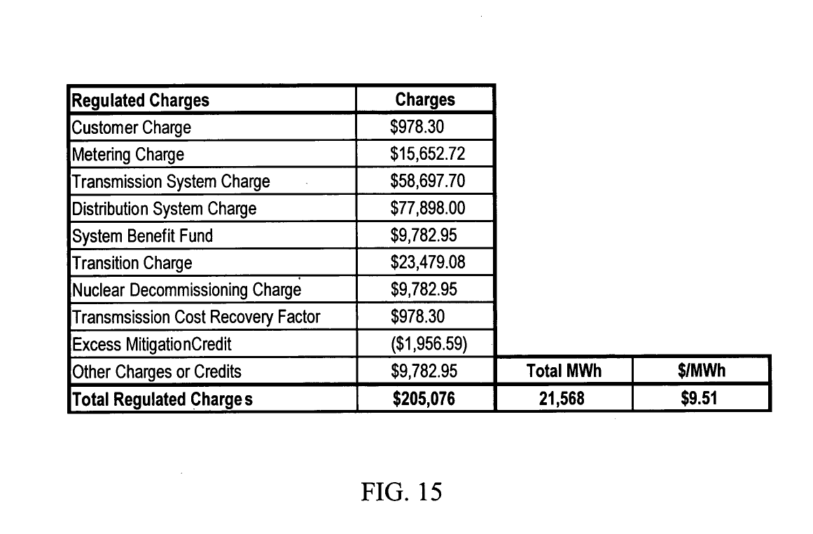

In addition to managing the transactions described above, the outsourcing service provider provides weekly (block 1120) and monthly reporting (block 1118) to the SSREP. As illustrated in FIGS. 12-15, these reports contain a set of essential information to help the SSREP manage its contracting activities and understand its contractual and financial positions. The monthly report (block 1118) includes the following information: (a) summary of historical monthly price data for baseload and peak periods, including monthly average prices and hourly price volatility; (b) a fundamental, stochastic forecast of pricing for wholesale energy products compared against prevailing forward market prices (FIGS. 12A-12B); (c) a summary of the SSREP's bilateral contractual positions with various Wholesale Energy Merchants (FIGS. 13A-13B); and (d) a summary of the SSREP's costs of electricity service (FIGS. 14-15).

The weekly report (block 1120) information includes: (a) a graph depicting a seven-day load forecast and bilateral contractual positions to highlight periods where the SSREP is expected to be long or short power; (b) a summary of recent market conditions, including a summary of prices in the energy spot or balancing markets; and (c) a summary of funds due to the ISO, TDSPs, and Wholesale Energy Merchants.

The outsourcing service provider also manages the reporting of information (block 1122) to the Public Utility Commission, ISO, the TDSPs, and other regulatory entities, as required by market rules and convention.

The present invention can be realized in a combination of software and hardware. Any kind of computer system or other apparatus adapted for carrying out the methods described herein is suited. A typical combination of hardware and software could be a general-purpose computer system that, when loaded and executed with the software, controls the computer system such that it carries out the methods described herein. The present invention can also be embedded in a computer program product, which comprises all the features enabling the implementation of the methods described herein, and which when loaded in a computer system, is able to carry out these methods.

Computer program instructions or computer program in the present context means any expression, in any language, code or notation, of a set of instructions intended to cause a system having an information processing capability to perform a particular function either directly or after either or both of the following occur: (a) conversion to another language, code or notation; (b) reproduction in a different material form.

Those skilled in the art will appreciate that many modifications to the preferred embodiment of the present invention are possible without departing from the spirit and scope of the present invention. In addition, it is possible to use some of the features of the present invention without the corresponding use of other features. Accordingly, the foregoing description of the preferred embodiment is provided for the purpose of illustrating the principles of the present invention and not in limitation thereof, since the scope of the present invention is defined solely by the appended claims.

1. A method for enabling a business to become a self-serving retail electricity provider in a deregulated market, comprising the steps of:
registering the business as a retail energy provider with a public utility commission;
assisting the business to qualify as a scheduling entity with an independent system operator; and
establishing the business as a bilateral trading partner with a wholesale energy merchant.

2. The method for enabling a business to become a self-serving retail electricity provider of claim 1 wherein the step of registering comprises processing and managing an application filing with the public utility commission and demonstrating an electronic data interchange capability to manage transactions with the independent service operator and a transmission and distribution service provider.

3. The method for enabling a business to become a self-serving retail electricity provider of claim 1 wherein the step of assisting the business to qualify as a scheduling entity comprises processing and managing an application filing with the independent service operator and demonstrating a electronic data interchange capability to send forecasts of the business' load requirements to the independent system operator and to receive financial settlement information from the independent system operator.

4. The method for enabling a business to become a self-serving retail electricity provider of claim 1 wherein the step of establishing the business as a bilateral trading partner comprises negotiating a contract with a wholesale energy merchant.

5. A method for assisting a self-serving retail electricity provider in energy purchasing and risk management decisions, comprising the steps of:
forecasting a zonal load requirement for the self-serving retail electricity provider;
analyzing the zonal load requirement for the self-serving retail electricity provider;
establishing a supply control strategy for the self-serving retail electricity provider;
performing an energy price forecasting analysis for the self-serving retail electricity provider and comparing the forecasted wholesale energy prices with supply offers available from wholesale energy merchants; and
brokering a bilateral transaction between the self-serving retail electricity provider and the wholesale energy merchant.

6. The method for assisting a self-serving retail electricity provider of claim 5 wherein the step of forecasting a zonal load requirement comprises performing a stochastic simulation of load for the self-serving retail electricity provider.

7. The method for assisting a self-serving retail electricity provider of claim 5 wherein the step of establishing a supply control strategy comprises an evaluation of a pricing structure, a product mix, a contract length, and use of financial risk management instruments.

8. The method for assisting a self-serving retail electricity provider of claim 7 wherein the pricing structure is at least one of fixed pricing, indexed pricing, and a hybrid combination of fixed and indexed pricing.

9. The method for assisting a self-serving retail electricity provider of claim 5 wherein the step of analyzing the zonal load requirement comprises establishing a baseload energy volume and supplementing the baseload energy volume with estimates of peak period purchases, shoulder period purchases and spot market purchases to develop a volumetric energy purchasing strategy.

10. The method for assisting a self-serving retail electricity provider of claim 5 wherein the step of performing an energy price forecasting analysis comprises performing a digital simulation of marginal clearing prices and deriving a price forecast for various time-differentiated energy purchases.

11. The method for assisting a self-serving retail electricity provider of claim 6 wherein performing a stochastic simulation of load for the self-serving retail electricity provider comprises the steps of generating a deterministic load forecast, estimating stochastic parameters for use in a Monte Carlo simulation of load, and performing the Monte Carlo simulation of load.

12. The method for assisting a self-serving retail electricity provider of claim 11 wherein the step of generating a deterministic load forecast uses any one of a scale factor technique, a comparative period technique or a regression-based technique.

13. The method for assisting a self-serving retail electricity provider of claim 12 wherein the scale factor technique includes the use of scale factors that reflect a percentage difference between an actual consumption and a generalized load for the rate class that is associated with the self-serving retail electricity provider.

14. The method for assisting a self-serving retail electricity provider of claim 12 wherein the comparative period technique includes a temperature adjustment and a seasonally specific elasticity for load responses to heating and cooling degree-days, and a calendar adjustment.

15. The method for assisting a self-serving retail electricity provider of claim 12 wherein the regression-based technique includes development and use of independent forecasting equations to account for weather, or any statistically relevant variable.

16. The method for assisting a self-serving retail electricity provider of claim 11 wherein the step of estimating stochastic parameters comprises the steps of:
collecting historical load data for the self-serving retail electricity provider;
generating an hourly or sub-hourly historical load profile;
correlating the historical load profile with actual market price data for energy during a historical time period to develop a seasonal correlation between load and market price;
performing a regression analysis based on the historical load profile and actual market price data; and
selecting a stochastic estimation model that reflects a historical behavior of both load data and energy market price data for the self-serving retail electricity provider.

17. The method for assisting a self-serving retail electricity provider of claim 16 wherein the step of estimating stochastic parameters further comprises deriving a plurality of short term stochastic parameters from the stochastic estimation model.

18. The method for assisting a self-serving retail electricity provider of claim 17 wherein the short term stochastic parameters include a seasonal short-run mean reversion and volatility parameter.

19. The method for assisting a self-serving retail electricity provider of claim 17 wherein the short term stochastic parameters include a correlation between a seasonal regression residual of historical load and actual market price data.

20. The method for assisting a self-serving retail electricity provider of claim 11 wherein the step of performing a Monte Carlo simulation of load comprises running a stochastic model to simulate energy prices and load consumption.

21. The method for assisting a self-serving retail electricity provider of claim 20 wherein the stochastic model used is a two-factor lognormal mean-reverting model.

22. The method for assisting a self-serving retail electricity provider of claim 20 wherein the stochastic model generates a plurality of sub-hourly marginal clearing prices for energy and a plurality of sub-hourly loads for the self-serving retail electricity provider.

23. The method for assisting a self-serving retail electricity provider of claim 5 further comprising the step of forecasting a variable-priced index power for the self-serving retail electricity provider.

24. The method for assisting a self-serving retail electricity provider of claim 24 wherein the step of forecasting a variable-priced index power comprises:
determining an indexed power volume for each hour;
determining a cost of the indexed power based on the indexed power volume and a corresponding forecast price for each hour;
determining a total cost of indexed power for all hours in an analysis period; and
displaying a graph of an annual total cost of indexed power in a plurality of annual cost ranges scaled by a probability of occurrence of each cost range.

25. The method for assisting a self-serving retail electricity provider of claim 5 further comprising the step of performing a price duration analysis for the self-serving retail electricity provider by sorting the forecast of wholesale energy prices and corresponding loads into a plurality of defined price ranges.

26. The method for assisting a self-serving retail electricity provider of claim 5 further comprising the step of performing a valuation of risk management instruments for the self-serving retail electricity provider.

27. The method for assisting a self-serving retail electricity provider of claim 26 wherein the risk management instruments include at least one of a cap on an indexed-based contract, a collar on an indexed-based contract, a contract extension option and a contract-for-differences.

28. The method for assisting a self-serving retail electricity provider of claim 26 wherein the valuation of the risk management instruments depends on a strike price, a forward price and a price volatility.

29. A method for assisting a self-serving energy provider to manage a plurality of electronic transactions with an independent service operator and a transmission and distribution service provider comprising the steps of:
submitting a request to both the independent service operator and transmission and distribution service provider to switch a metered account to the self-serving energy provider;
updating the daily load forecast for the self-serving energy provider;
comparing the daily load forecast with a wholesale energy purchase commitment to identify periods of imbalance between an energy supply and a consumption demand for the self-serving energy provider;
submitting a daily schedule of forecasted sub-hourly load and purchase and sale commitments to the independent service operator;
receiving and processing an invoice from at least one market participant; and
generating financial settlement reports for the self-serving energy provider.

30. The method for assisting a self-serving energy provider of claim 29 further comprising the step of providing a secure, online payment system to the self-serving energy provider to review charges and to transfer funds to the at least one market participant.

31. The method for assisting a self-serving energy provider of claim 29 wherein the at least one market participant includes the independent service operator, transmission and distribution service provider, and a wholesale energy merchant.

32. The method for assisting a self-serving energy provider of claim 29 further comprising completing and providing required reports to at least one of a public utility commission, the independent service operator, the transmission and distribution service provider, and any other regulatory entity.
